(19) United States
(12) Patent Application Publication
(10) Pub. No.: US 2022/0235685 A1
(43) Pub. Date: Jul. 28, 2022

(54) EXHAUST AFTERTREATMENT DEVICE

(71) Applicant: Vitesco Technologies GMBH, Regensburg (DE)

(72) Inventor: Rolf Bruck, Bergisch Gladbach (DE)

(73) Assignee: Vitesco Technologies GMBH, Regensburg (DE)

(21) Appl. No.: 17/718,103

(22) Filed: Apr. 11, 2022

Related U.S. Application Data
(63) Continuation of application No. PCT/EP2020/078123, filed on Oct. 7, 2020.

(30) Foreign Application Priority Data
Oct. 11, 2019 (DE) 102019215631.2

(51) Int. Cl. F01N 3/20; F01N 3/28; F01N 3/08; B01D 53/94

(52) U.S. Cl. CPC F01N 3/2013; F01N 3/28; F01N 3/0842; B01D 2255/9155; B01D 53/9486; B01D 2255/91; B01D 2255/912; F01N 3/0835

(57) ABSTRACT

An apparatus for treating exhaust gases of an internal combustion engine having at least one main catalytic converter for chemical conversion of at least one exhaust gas component, having a hydrocarbon trap for intermediate storage of hydrocarbons, having a nitrogen oxide adsorber for intermediate storage of nitrogen oxides and having an electrically heatable heated catalytic converter, wherein the abovementioned components are arranged in a spatially delimited flow path and are traversed consecutively.

### CROSS-REFERENCE TO RELATED APPLICATIONS

This application claims priority to PCT Application PCT/EP2020/078123, filed Oct. 7, 2020, which claims priority to German Patent Application No. DE 10 2019 215 631.2, filed Oct. 11, 2019. The disclosures of the above applications are incorporated herein by reference.

### FIELD OF THE INVENTION

The invention relates to an apparatus for treating exhaust gases of an internal combustion engine having at least one main catalytic converter for chemical conversion of at least one exhaust gas component, having a hydrocarbon trap for intermediate storage of hydrocarbons, having a nitrogen oxide adsorber for intermediate storage of nitrogen oxides and having an electrically heatable heated catalytic converter, wherein the abovementioned components are arranged in a spatially delimited flow path and are traversed consecutively.

### BACKGROUND OF THE INVENTION

The use of so-called HC traps or hydrocarbon traps in the exhaust tract is known for the purpose of exhaust gas aftertreatment. The objective of the use is the reduction of hydrocarbons, such as especially unburnt fuel, entrained in the exhaust gas. Such HC traps are formed, for example, by a zeolite-coated monolithic catalyst support.

DE 691 27 377 T2 discloses the use of an HC trap in the exhaust tract and shows in particular possible arrangements of the various components for exhaust gas aftertreatment.

A disadvantage of the prior art apparatuses is in particular that the exhaust gas aftertreatment is not optimally solved since especially nitrogen oxides cannot be sufficiently removed from the exhaust gas in the different operating scenarios of a motor vehicle. This is the case especially at low temperatures.

### SUMMARY OF THE INVENTION

The problem addressed by the present invention is accordingly that of providing an apparatus for exhaust gas aftertreatment which allows improved purification of the exhaust gas in different operating states of a motor vehicle.

The problem relating to the apparatus is achieved by an apparatus having the features described.

One exemplary embodiment of the invention relates to an apparatus for treating exhaust gases of an internal combustion engine having at least one main catalytic converter for chemical conversion of at least one exhaust gas component, having a hydrocarbon trap for intermediate storage of hydrocarbons, having a nitrogen oxide adsorber for intermediate storage of nitrogen oxides and having an electrically heatable heated catalytic converter, wherein the abovementioned components are arranged in a spatially delimited flow path and are traversed consecutively.

The combination of a hydrocarbon trap with a nitrogen oxide adsorber upstream of a heated catalytic converter provides for ensuring optimal exhaust gas aftertreatment. The hydrocarbon trap is adapted for taking up and at least temporally binding hydrocarbons present in the exhaust gas. This is especially the case for as long as the exhaust gas temperature is below a minimum temperature. Hydrocarbons may thus be bound during cold start while the exhaust gas temperatures are not yet high enough to ensure sufficient functioning of the downstream main catalytic converters. The hydrocarbon trap is thus effective before reaching the so-called light-off temperature, above which the main catalytic converter is most effective. As a consequence of the material or the coating of the hydrocarbon trap, upon reaching the light-off temperature, the hydrocarbons are desorbed again and released into the exhaust gas stream.

Due to the combination with a heated catalytic converter, which is electrically heated and which is arranged downstream of the hydrocarbon trap, the desorption temperature could also be slightly below the light-off temperature of the main catalytic converter, since the heated catalytic converter also supplies thermal energy that may close this delta.

The nitrogen oxide adsorber has a coating that differs from the hydrocarbon trap and has the objective of binding nitrogen oxides from the exhaust gas at a low temperature level and desorption at an appropriately higher temperature level. Similarly to the hydrocarbon trap, adsorption and desorption is ideally tied to the light-off temperature of the respective main catalytic converter provided for the respective conversion of the exhaust gas component.

The adsorption temperature, up to which hydrocarbons or nitrogen oxides are taken up, and the desorption temperature, above which the bound hydrocarbons or nitrogen oxides are released, may be different for the hydrocarbon trap and the nitrogen oxide adsorber. These temperatures are essentially determined by the selected substrate material and the coating applied to it.

In an embodiment, the hydrocarbon trap and the nitrogen oxide adsorber are arranged upstream of the electrically heatable heated catalytic converter in the flow direction of the exhaust gas.

The hydrocarbon trap and the nitrogen oxide adsorber are used in an area of low exhaust gas temperature since this is where they are able to exert their effect and thus improves the exhaust gas purification at an altogether low temperature level, such as below 200 degrees Celsius. The electrically heatable heated catalytic converter is then provided for additional heating of the exhaust gas stream and thus the downstream main catalytic converters.

In an embodiment, the hydrocarbon trap and the nitrogen oxide adsorber are each in the form of an individual assembly and are arranged in the flow path consecutively in the flow direction. The use of individual assemblies and components for the hydrocarbon trap and the nitrogen oxide adsorber allow for the highest possible flexibility in terms of placement, construction, choice of material and choice of coating. The individual components may thus be readily adapted to the respective application.

One exemplary embodiment is characterized in that the hydrocarbon trap and the nitrogen oxide adsorber are in the form of a combined assembly. A combined assembly by contrast is used when the most compact design possible is sought. A combined assembly may be for example a common honeycomb made of a uniform substrate material and be provided with coatings, forming a portion which acts as a hydrocarbon trap and a portion which acts as a nitrogen oxide adsorber, according to the desired division.

In an embodiment, the nitrogen oxide adsorber is a passive nitrogen oxide adsorber which intermediately stores nitrogen oxides from the exhaust gas at a low temperature level, for example below 200 degrees Celsius, and re-releases them into the exhaust gas stream at a higher temperature level. A passive nitrogen oxide adsorber has the feature that it takes up nitrogen oxides from the exhaust gas, intermediately stores them and re-releases them at a higher temperature level. Active conversion of the nitrogen oxides, such as for example over an SCR catalytic converter, where a chemical conversion of the nitrogen oxides is performed utilizing ammonia, is not carried out here. A passive nitrogen oxide adsorber thus supplements active exhaust gas aftertreatment and thus provides an overall improvement to exhaust gas aftertreatment.

In an embodiment, the hydrocarbon trap, the nitrogen oxide adsorber and the electrically heatable heated catalytic converter are each formed by a honeycomb traversable along a main flow direction. To this end it is possible to utilize honeycombs made of metal formed by the use of at least partially structured and smooth metal films which are stacked on top of one another and wound up. It is alternatively also possible to use appropriately coated ceramic supports.

In an embodiment, the desorption temperature of the hydrocarbon trap and/or of the nitrogen oxide adsorber and the light-off temperature of the main catalytic converter arranged downstream in the flow direction are identical or the light-off temperature is somewhat below the desorption temperature.

This provides for ensuring that the adsorbed exhaust gas constituents are only desorbed again when the main catalytic converters are sufficiently heated to ensure effective exhaust gas aftertreatment.

Other developments of the present invention are described in the following description of the Figures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will be elucidated in detail hereinbelow on the basis of exemplary embodiments with reference to the drawings. In the drawings:

FIG. 1 shows a schematic view of an exhaust tract connected downstream of an internal combustion engine with a hydrocarbon trap and a nitrogen oxide adsorber; and

FIG. 2 shows a further schematic view of an exhaust tract connected downstream of an internal combustion engine with a hydrocarbon trap and a nitrogen oxide adsorber.

### DETAILED DESCRIPTION OF THE PREFERRED EMBODIMENTS

The following description of the preferred embodiment(s) is merely exemplary in nature and is in no way intended to limit the invention, its application, or uses.

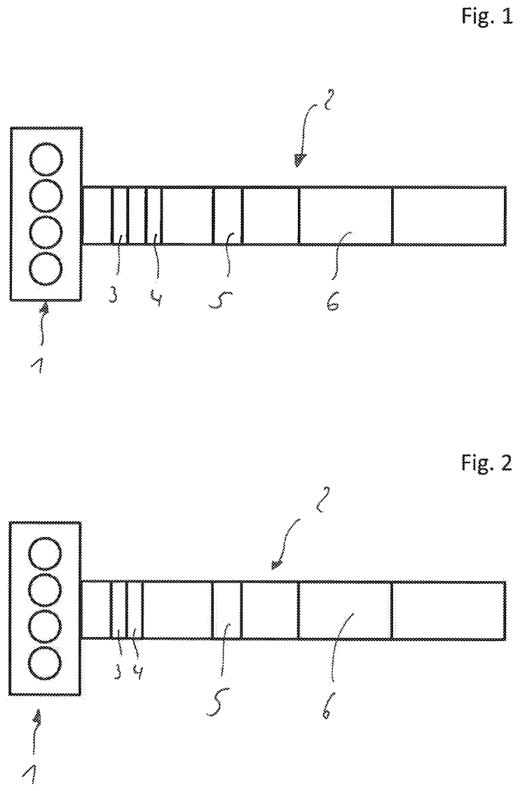

FIG. 1 shows an internal combustion engine 1. The exhaust gases of the internal combustion engine 1 are passed into the exhaust tract 2 which represents a flow path for the exhaust gas. A hydrocarbon trap 3 and a nitrogen oxide adsorber 4 are arranged within the flow path 2. These may also be arranged in reverse order. Arranged downstream thereof in the flow direction is an electrically heatable heated catalytic converter 5 and downstream thereof at least one main catalytic converter having reference numeral 6 which may be for example an oxidation catalytic converter or an SCR catalytic converter.

FIG. 2 shows a similar construction as a result of which the employed reference numerals are identical. The difference compared to FIG. 1 is that the hydrocarbon trap 3 and the nitrogen oxide adsorber 4 are in the form of a combination as a common assembly. Here, too, the sequence of the hydrocarbon trap and the nitrogen oxide adsorber may be reversed.

The exemplary embodiments in FIGS. 1 and 2 are not of a limiting nature and serve to elucidate the inventive concept.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for treating exhaust gases of an internal combustion engine comprising:
at least one main catalytic converter for chemical conversion of at least one exhaust gas component;
a hydrocarbon trap for intermediate storage of hydrocarbons;
a nitrogen oxide adsorber for intermediate storage of nitrogen oxides; and
an electrically heatable heated catalytic converter;
wherein the at least one main catalytic converter, the hydrocarbon trap, the nitrogen oxide adsorber, and the electrically heatable heated catalytic converter are arranged in a spatially delimited flow path and are traversed consecutively.

2. The apparatus of claim 1, wherein the hydrocarbon trap and the nitrogen oxide adsorber are arranged upstream of the electrically heatable heated catalytic converter in the flow direction of the exhaust gas.

3. The apparatus of claim 1, wherein the hydrocarbon trap and the nitrogen oxide adsorber are each in the form of an individual assembly and are arranged in the flow path consecutively in the flow direction.

4. The apparatus of claim 1, wherein the hydrocarbon trap and the nitrogen oxide adsorber are in the form of a combined assembly.

5. The apparatus of claim 1, the nitrogen oxide adsorber further comprising a passive nitrogen oxide adsorber wherein the passive nitrogen oxide absorber intermediately stores nitrogen oxides from the exhaust gas at a first temperature level, and re-releases the nitrogen oxides into the exhaust gas stream at a second temperature level, the second temperature level higher than the first temperature level.

6. The apparatus of claim 5, wherein the first temperature level is below 200 degrees Celsius.

7. The apparatus of claim 1, wherein the hydrocarbon trap, the nitrogen oxide adsorber and the electrically heatable heated catalytic converter are each formed by a honeycomb traversable along a main flow direction.

8. The apparatus of claim 1, wherein the desorption temperature of the hydrocarbon trap and the nitrogen oxide adsorber is identical to or above the light-off temperature of the main catalytic converter arranged downstream in the flow direction.

9. The apparatus of claim 1, wherein the desorption temperature of the hydrocarbon trap or the nitrogen oxide adsorber is identical to or above the light-off temperature of the main catalytic converter arranged downstream in the flow direction.
